(19) United States
(12) Patent Application Publication
(10) Pub. No.: US 2023/0094480 A1
(43) Pub. Date: Mar. 30, 2023

(54) REMOVABLE AND TRANSPARENT VEHICLE TOP COMPRISING ONE OR MORE LIGHTING ELEMENTS

(71) Applicant: Kassie Te’heira Felder, Fayetteville, NC (US)

(72) Inventor: Kassie Te’heira Felder, Fayetteville, NC (US)

(21) Appl. No.: 17/954,755

(22) Filed: Sep. 28, 2022

Related U.S. Application Data
(60) Provisional application No. 63/249,406, filed on Sep. 28, 2021.

(51) Int. Cl. B60J 7/16; B60Q 3/51; B60Q 1/26

(52) U.S. Cl. CPC B60J 7/1642; B60Q 1/2611; B60Q 3/51

(57) ABSTRACT

The invention is directed to a vehicle top that can be used with an SUV or other jeep-like vehicle with a removable top. The disclosed top includes a transparent portion, which include a sunroof comprising one or more panels. The top can further include interior lighting elements that allow the interior of the vehicle to be illuminated as desired by the use. The lighting elements can be customizable with regard to placement, color, light pattern, intensity, and the like. The lighting element and sunroof can be controlled wirelessly through the user’s phone or other device or can be manually operated.

### CROSS-REFERENCE TO RELATED APPLICATIONS

This application claims priority to U.S. Provisional Pat.Application No.63/249,406 filed Sep. 28, 2021, the entire content of which is hereby incorporated by reference.

### TECHNICAL FIELD

The presently disclosed subject matter is generally directed to a removable and vehicle top (e.g., Jeep® top) comprising one or more lighting elements and at least one transparent section.

### BACKGROUND

Sport utility vehicles (SUVs) have become very popular, particularly those with removable tops. Many variations for rooftops of jeep-type vehicles have been designed to provide versatility and ease of removal/installation as desired by the owner. For example, conventional removable tops are either hard or soft and can be made of single or multiple pieces. While traditional hard tops are sturdy and provide protection, they are bulky and can be difficult to handle. In comparison, soft tops of canvas or vinyl are relatively simple to attach and remove from the vehicle because they are lightweight and flexible. However, soft tops often leak and tend to let in large amounts of road and traffic noise. In addition, neither hard nor soft vehicle tops allow the occupants to see the sky when the top is installed on the vehicle. Further, conventional SUV or jeep-type vehicle tops typically lack interior lighting which limits the amount of enjoyment associated with these vehicles. It would therefore be beneficial to provide a removable jeep-type vehicle top comprising a transparent portion (e.g., sunroof) and one or more integrated lighting elements.

### SUMMARY

In some embodiments, the presently disclosed subject matter is directed to a removable vehicle top. Specifically, the vehicle top comprises a top surface and an opposed bottom surface, a length, and a width. The top also includes one or more fasteners configured to releasably or permanently attach the top to a corresponding vehicle. The top includes a sunroof that extends through a central portion of the top, and one or more lighting elements positioned on one surface of the top. Advantageously, the top is removable on a vehicle.

In some embodiments, the sunroof is a panoramic sunroof.

In some embodiments, the top further includes one or more legs that extend from the bottom surface of the top, wherein the one or more legs cooperate with the vehicle to stabilize the top.

In some embodiments, the sunroof is at least partially transparent.

In some embodiments, the sunroof comprises one or more panels constructed from plastic, tempered glass, or combinations thereof.

In some embodiments, the top includes an opaque or partially opaque covering configured to extend over the sunroof.

In some embodiments, the transparent portion of the sunroof is tinted.

In some embodiments, the bottom surface of the top comprises a seal that extends about the perimeter of the top.

In some embodiments, the seal is constructed from foam, neoprene, silicone, or combinations thereof.

In some embodiments, the lighting elements are selected from LED lights, halogen lights, electroluminescent lights, fluorescent lights, or combinations thereof.

In some embodiments, the lighting elements are releasably attached to the top and customizable by a user.

In some embodiments, each lighting element can be activated simultaneously or separate from another lighting element.

In some embodiments, the one or more lighting elements can comprise white lights, colored lights, or both.

In some embodiments, the sunroof, one or more lighting elements, or both can be controlled wirelessly by a user’s phone, tablet, or other device.

In some embodiments, the lighting elements are powered by batteries, solar panels, or the vehicle power source.

In some embodiments, the presently disclosed subject matter is directed to a vehicle comprising the disclosed top.

In some embodiments, the presently disclosed subject matter is directed to a method of positioning a top on a vehicle comprising a removable top. Specifically, the method comprises positioning a removable top over an opening in the roof of a vehicle. The removable top is defined by: a top surface and an opposed bottom surface; a length; a width; one or more fasteners configured to releasably or permanently attach the top to a corresponding vehicle; a sunroof that extends through a central portion of the top; and one or more lighting elements positioned on one surface of the top. The method includes securing the removable top to the vehicle, whereby the top is positioned on the vehicle.

### BRIEF DESCRIPTION OF THE DRAWINGS

FIG. 1 is a side plan view of a vehicle comprising a top in accordance with some embodiments of the presently disclosed subject matter.

FIG. 2a is a side plan view of a vehicle top in accordance with some embodiments of the presently disclosed subject matter.

FIG. 2b is a side plan view of a tapered vehicle top in accordance with some embodiments of the presently disclosed subject matter.

FIG. 2c is a top plan view of a vehicle top in accordance with some embodiments of the presently disclosed subject matter.

FIG. 2d is a top plan view of a vehicle top in accordance with some embodiments of the presently disclosed subject matter.

FIG. 3a is a top plan view of a vehicle top comprising a sunroof in accordance with some embodiments of the presently disclosed subject matter.

FIG. 3b is a top plan or bottom plan view of a vehicle top comprising a transparent panel in accordance with some embodiments of the presently disclosed subject matter.

FIG. 4a is a top plan view of a covering in accordance with some embodiments of the presently disclosed subject matter.

FIG. 4b is a top plan view of a covering comprising lighting elements in accordance with some embodiments of the presently disclosed subject matter.

FIG. 5 is a bottom plan view of a vehicle top comprising a perimeter seal in accordance with some embodiments of the presently disclosed subject matter.

FIG. 6a is a bottom plan view of a vehicle top comprising a lighting element in accordance with some embodiments of the presently disclosed subject matter.

FIG. 6b is a bottom plan view of a vehicle top comprising a series of lighting elements in accordance with some embodiments of the presently disclosed subject matter.

FIGS. 7a and 7b are perspective view of power connectors used with lighting elements in accordance with some embodiments of the presently disclosed subject matter.

FIG. 7c is a perspective view of a battery that can be used to power a lighting element in accordance with some embodiments of the presently disclosed subject matter.

FIG. 7d is a perspective view of a solar panel that can be used to power a lighting element in accordance with some embodiments of the presently disclosed subject matter.

FIG. 8 is a perspective view of one method of installing a top on a vehicle in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/-20%, in some embodiments +/-10%, in some embodiments +/-5%, in some embodiments +/-1%, in some embodiments +/-0.5%, and in some embodiments +/-0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The presently disclosed subject matter is generally directed to a removable vehicle top comprising one or more lighting elements. Traditionally, SUVs and other jeep-type vehicles with removable tops are limited in the amount of interior light available. As such, the interiors of these vehicles tend to be dark, making it difficult to see at night or in rainy conditions. In response, the disclosed top includes at least one transparent portion to let in ambient light. The transparent portion can be configured as a sunroof or other transparent openings (e.g., windows, clear panels, etc.). In addition, the disclosed top can include one or more lighting elements that provide additional visibility when activated by the user.

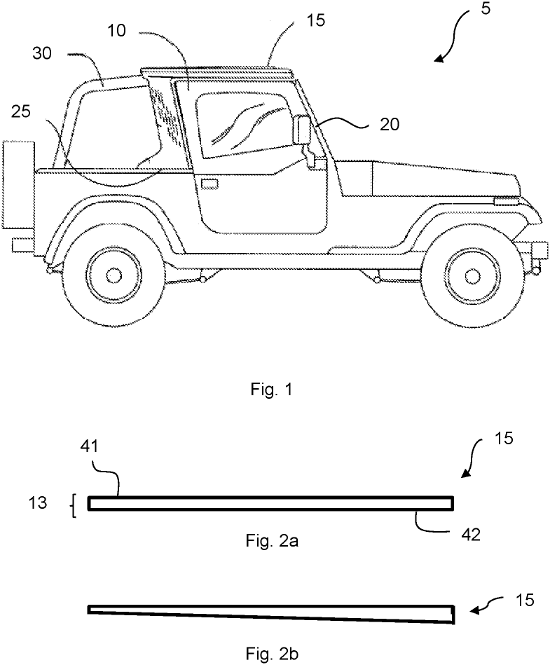

The term “vehicle” generally refers to any automobile with a removable top, such as an SUV, jeep-type vehicle (e.g., a CJ-7 or Wrangler®) or any vehicle having four wheels and exhibiting the characteristics of a removable top. One embodiment of vehicle 5 is illustrated in FIG. 1. As shown, the vehicle includes two or more doors 10 that can be optionally removed from body 25, allowing occupants to enter and exit the vehicle. Top 15 is attached to the upper surface of the vehicle, providing a sunroof and lighting elements, as discussed in detail below. The vehicle further includes a front windshield 20 and a rear cab that can include roll bars 30. Advantageously, top 15 can be quickly and conveniently installed on a roof or opening of the vehicle.

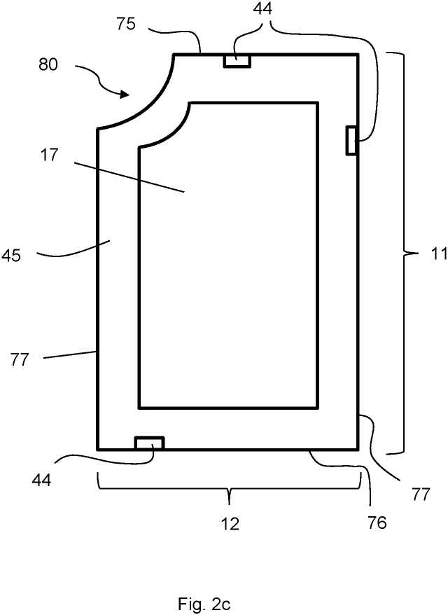

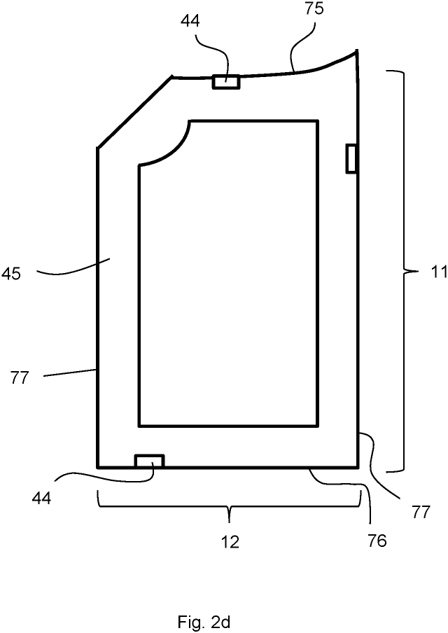

FIG. 2a illustrates a side plan view of top 15 comprising upper surface 41 and opposed lower surface 42. The upper surface of the top is in contact with the outside environment and therefore is exposed to rain, sunlight, and the like. The lower surface of the top is positioned within the interior of the vehicle cabin when installed. In some embodiments, the top can be tapered from front to back (or back to front) to increase stability, as shown in FIG. 2b.

The top also includes top edge 75, opposed bottom edge 76, and parallel side edges 77 that are interconnected. The top edge can be towards the front of the vehicle and the bottom edge can be towards the rear of the vehicle. The top and bottom edges can be parallel to each other or about parallel to each other in some embodiments, as shown in FIG. 2c. For example, the top and bottom edges can be about horizontal. The side edges can further be configured to be about perpendicular relative to at least one of the top or bottom edges. However, the presently disclosed subject matter includes embodiments wherein one or more edges of the top are angled and/or non-parallel with the opposing edge, as shown in the embodiment of FIG. 2d.

The top includes length 11, width 12, and thickness 13. The term “length” refers to the longest horizontal distance of the top. The term “width” refers to the longest vertical distance of the top. The term “thickness” refers to the distance between the upper and lower surfaces 41, 42. In some embodiments, top 15 can have a length and/or width of about 5-25 feet (e.g., at least/no more than about 5, 10, 15, 20, or 25 feet). The top thickness can be about 1-10 inches or more (e.g., at least/no more than about 1, 2, 3, 4, 5, 6, 7, 8, 9, or 10 inches). However, it should be appreciated that the top is not limited by the length, width, and thickness ranges given above and can be configured with any desired dimensions.

Border 45 extends around the perimeter of top 15, around the transparent regions. The border can be constructed from molded fiberglass, metal, rigid plastic, and the like. In some embodiments, the border can include UV inhibitors for a long and reliable product life. The border can include thickness 16 of about 0.1-10 inches, extending about the edge of the top (e.g., at least/no more than about 0.1, 0.5, 1, 2, 3, 4, 5, 6, 7, 8, 9, or 10 inches). The border can be used to stabilize the interior region of the top (e.g., provide for proper fitting, ensure that the middle portion does not move/adjust, etc.).

In some embodiments, the top can include cutout region 80 that allows the top to snugly fit on the top portion of a vehicle. For example, the cutout region can accommodate the roll bars or other portions of the vehicle frame. In some embodiments, cutout regions 75 can be circular or rounded, as shown in FIG. 2b. However, the cutout region can be angled or linear, as shown in the embodiment of FIG. 2d. Thus, one corner of the top can include an angled edge or a rounded edge to facilitate cooperation and attachment with the vehicle. The border can extend around the edge of the top, including any cutout regions as shown.

The top can include one or more latches 44 that secure the top to the body of the vehicle. The term “latch” refers to any element that releasably attaches the top to the vehicle, such as (but not limited to) clamps, straps, mechanical elements (screws, bolts), clips, magnets, and the like. In some embodiments, latch 44 cooperates with a corresponding receiver positioned on the vehicle body or frame to secure the top in place.

In some embodiments, the vehicle top 15 is at least partially transparent. The term “transparent” refers to a property of a material to permit transmission of at least 50% incident light in the visible range. Thus, one or more areas of the disclosed vehicle top can permit transmission of at least about (or no more than about) 50, 60, 70, 80, 90, or 100% incident light in the visible range. In some embodiments, the entire vehicle top is transparent. In other embodiments, only select portions or sections of the vehicle top is transparent. For example, the border, cutout region, and/or latches can be transparent, partially-transparent, or opaque in some embodiments.

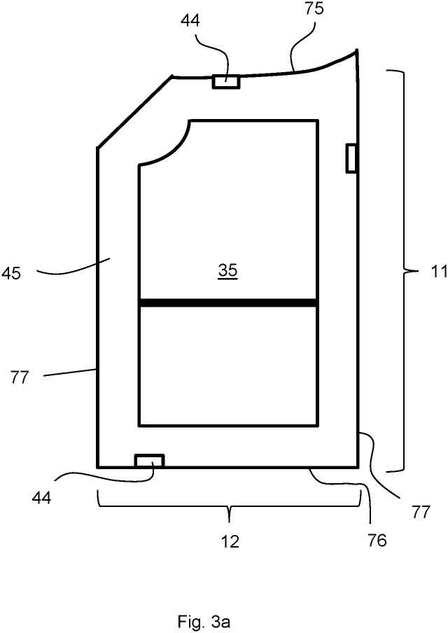

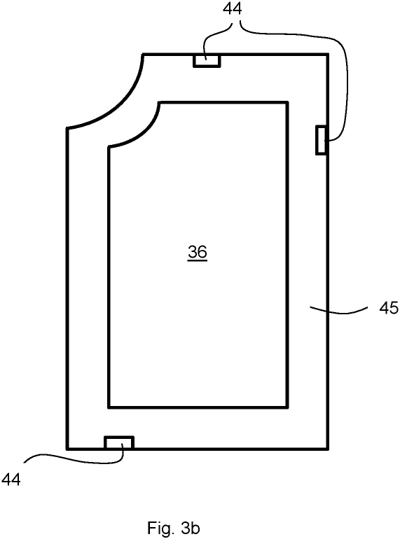

The transparent portions 17 of top 15 can be configured as at least one sunroof 35. The term “sunroof” broadly refers to a functioning device that allows light or fresh air to flow into the interior of a vehicle as a fixed or operating (bent or sliding) opening present in the ceiling of the vehicle. The term “panoramic roof” refers a type of sunroof that spans all or substantially all of the entire top surface of a vehicle, typically including one or two panels (e.g., glass panels). Thus, the transparent portions of the disclosed top can include a sunroof or panoramic roof for a vehicle, providing a clear view of the sky while also protecting passengers from direct exposure to sunlight, heat, glare, and the like. One embodiment of top 15 comprising sunroof 35 is illustrated in FIG. 3a. As shown, a sunroof can be centrally positioned over the driver and front passenger side of the vehicle. Alternatively, the sunroof can encompass the majority of the upper surface of the top, such as with the panoramic roof described above.

In place of a sunroof, in some embodiments the transparent portion can be configured as at least one transparent stationary panel 36 (e.g., the panel does not open or otherwise move), as shown in FIG. 3b.

The transparent portions of the top can include any transparent material, such as plastic, glass, and the like. In some embodiments, tempered glass can be used for strength and high transparency. “Tempered glass” refers to glass that has been subjected to a chemical or thermal tempering treatment to increase its strength compared to normal glass. Tempering puts the outer surfaces into compression and the interior surfaces into tension. Such stresses cause the glass when broken to shatter into small granular chunks instead of splintering into jagged pieces.

The transparent portion of the top can be tinted to filter out bright sunlight and glare while still allowing occupants to view the sky and outdoor environment. For example, the transparent portion can have a coating to filter out UV light in some embodiments.

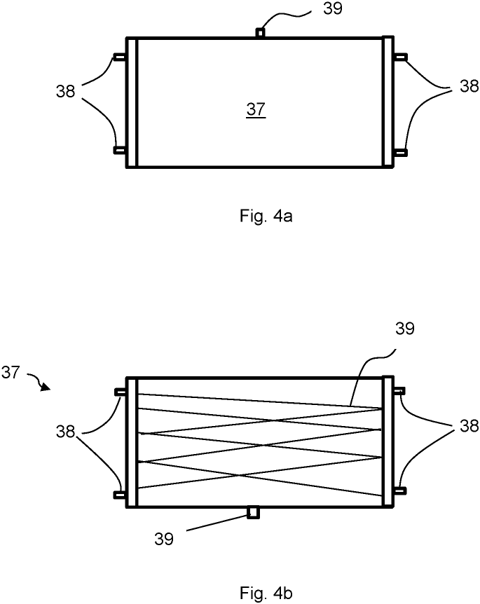

In some embodiments, the sunroof or transparent panel can be covered as desired by the user using portable covering 37 that provides an opaque or partially opaque cover over the transparent regions of the top and/or the border, as shown in FIG. 4a. In this way, exposure of the passengers to the sun is at least partially blocked. The covering can be secured over all or a portion of the sunroof or top using latches 38, although straps, magnets, or any other attachment mechanism can be used. Covering 37 can be retractable, allowing only a portion of the transparent portion of the top to be exposed. In this way, one particular area of the vehicle

In some embodiments, the covering can include lights 39 (e.g., string lights), as shown in FIG. 4b. Cover lights 39 can be selected from LED lights, halogen lights, electroluminescent lights, fluorescent lights, or combinations thereof. The lights can be included in any desired pattern or configuration, such as a crisscross pattern, loops, linear strands, and the like. Power for the lights can be provided via power connector 39 that allows attachment to any power source, such as the vehicle battery, external battery, and the like. The power connector can be positioned on any surface of the covering.

Covering 37 can be constructed from any material, such as fabric, plastic, metal, or combinations thereof. When not in use, the covering can be easily stored in the vehicle cabin or trunk until needed.

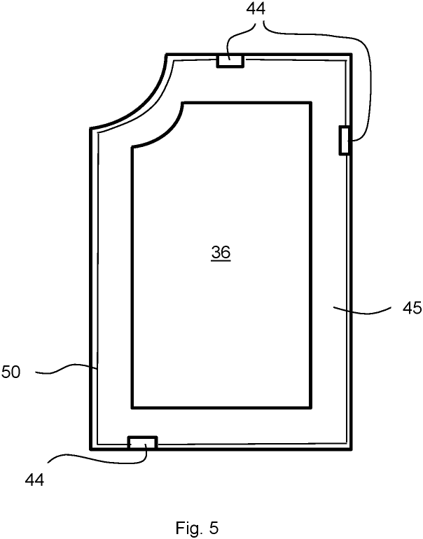

To filter out noise, weather, moisture, the lower surface of top 15 can include seal 50 to allow the top to be securely and reliably attached to the vehicle body, as shown in FIG. 5. The term “seal” refers to any material that acts as a barrier or buffer between the top and the body of the vehicle when installed. Thus, seal 50 can include any desired material, such as foam, neoprene, silicone, and the like. Seal 50 can extend about the perimeter of the top on the upper surface, lower surface, or both. The seal therefore acts as a protective and insulative element. Specifically, the seal creates a secure barrier between the vehicle and the top, thereby preventing moisture (e.g., rain, sleet, snow) from entering the interior of the vehicle. The seal further provides an insulative quality, keeping cool or warm air within the interior of the vehicle as desired by the user. In addition, the seal can help reduce interior noise for the driver and passengers. The seal can be permanently affixed to the top (e.g., through welding, adhesive, and the like) or can be removably attached (such as to facilitate repair of the seal or replacement).

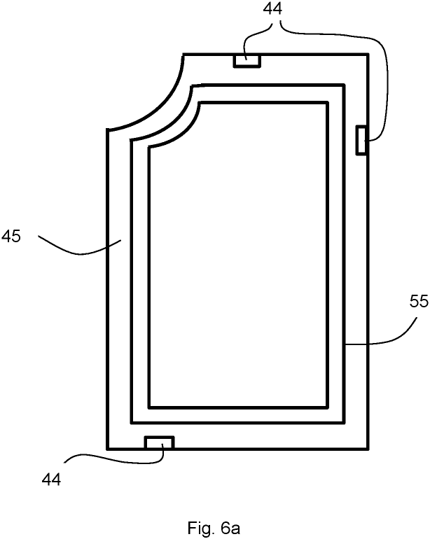

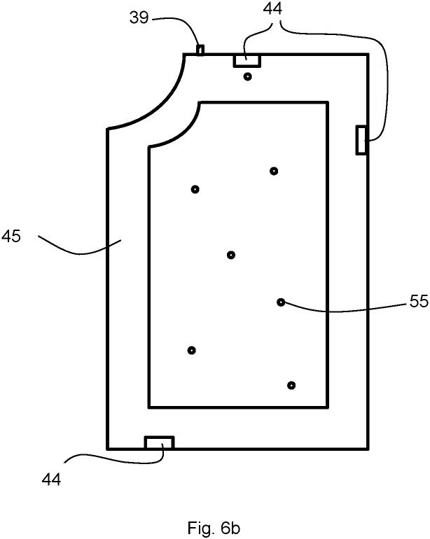

In some embodiments, top 15 can include one or more integrated lighting elements. The term “lighting element” broadly refers to any element that can provide light within the vehicle interior or exterior. Suitable lighting elements can include (but are not limited to) LED lights halogen lights, electroluminescent lights, fluorescent lights, or combinations thereof. One embodiment of lighting element 55 is shown in FIG. 6a. The lighting element can be configured about the perimeter of the upper and/or lower surface of the top, as shown. Alternatively or in addition, the lighting element can be positioned within the transparent portion to provide additional lighting within the interior of the vehicle cabin, as shown in FIG. 6b. Any system can be used to mount the lighting elements. In some embodiments, lighting elements 55 are customizable, allowing the owner to place the lights in any desired location on the interior or exterior of the top. For example, the lights can attach to one surface of top 15 using magnets, VELCRO®, ties, snaps, fasteners, snap-fit closure, pressure-fit closure, and the like. Thus, lighting elements 55 can be permanently affixed in location in some embodiments and/or can be removably positioned as desired by the user. For example, the user can customize the lighting elements to spell a name, create a symbol (e.g., a star), or maneuver the lights in any suitable shape or orientation.

When more than a single light element is used, each light can be controlled independently from the rest. Further, the lighting elements can be activated simultaneously or separately. In this way, the amount of light can be customized by the owner. For example, a series of lights positioned around the perimeter of the top can be selected on or off. In other embodiments, the lights can be powered on or off by color (e.g., blue lights on during a bright afternoon).

Lighting elements 55 can optionally be configured to emit any of a wide variety of colors or patterns. Thus, the lighting element can emit standard white color for maximum visibility. In addition, the lighting elements can optionally be customized to any desired color (e.g., blue, yellow, orange, red, green, purple). Further, the lighting can also be configured to transmit a theme of colors, such as team colors (blue and yellow, for example), or shuffle through a range of colors. The lights can also emit a steady beam of light or can pulse or waver as desired by the user. Further, the brightness of the light can be dimmed or intensified. The user can control the light using a remote control, voice-activated commands, and/or a dial on the lighting elements. In some embodiments, the lighting elements can be controlled wirelessly, such as through a mobile application on a smart device (e.g., the user’s phone or tablet).

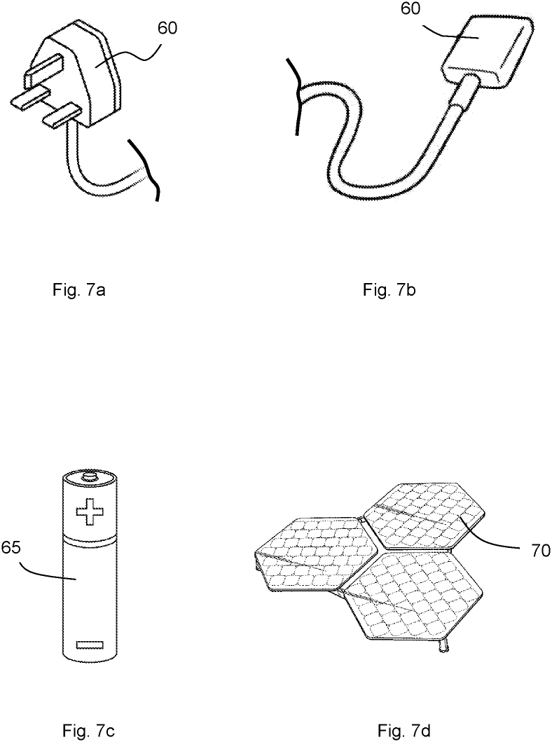

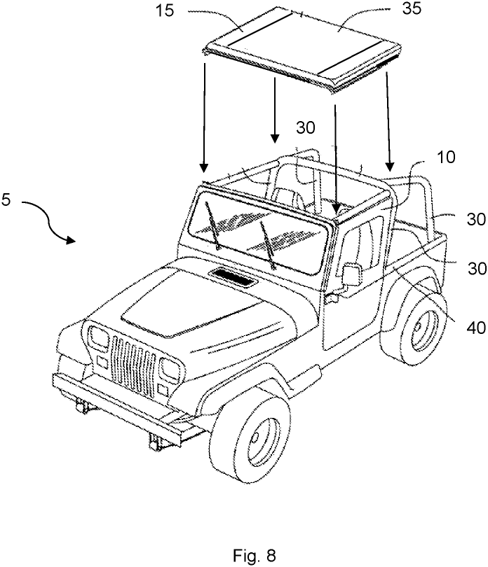

Lighting element 55 is configured with connector 39 that allows for connection to a power source 39 such as a battery or the vehicle electrical system. The lighting element(s) can include connector to plug into a power source for providing power, as shown in FIGS. 7a and 7b. The term “connector” refers to any element that allows for the provision of a power source to lighting elements 55. Alternatively, one or more batteries 65 can be used to power the lighting elements, as shown in FIG. 7c. In still other embodiments, the one or more lighting elements can be solar powered, including one or more solar panels 70 as shown in FIG. 7d. All corresponding wiring for the lighting elements can be configured within the interior of the top and are thereby protected from damage and exposure to the elements.

Advantageously, the lighting elements provide an attractive glow to the interior and exterior of the vehicle, especially when the doors are removed. Accordingly, the interior of the vehicle has a very distinctive appearance while also enabling the vehicle to be customized as desired by the owner.

Top 15 can be constructed from any resilient material, such as (but not limited to) glass, fiberglass, metal, plastic, and the like. The materials used to construct the top are strong enough to provide protection from weather elements such as wind, rain, hail, sleet, and snow. In addition, the materials are strong enough to provide protection for the driver and passengers from debris while driving.

In use, top 15 can easily slide into position on the vehicle rooftop, being secured into position using conventional retention elements, such as latches, clamps, and the like, as shown in FIG. 6. Specifically, the top can be quickly and conveniently installed on a roof or opening of the vehicle. In some embodiments, the top can snugly fit over the rollbar of the vehicle.

Top 15 provides many advantages over prior art SUV and jeep-like vehicle tops. Specifically, the disclosed sunroof feature adds comfort and an added safety feature to the vehicle, allowing occupants to better visualize the internal surroundings of the vehicle.

Top 15 creates an open-air feeling to the vehicle provided by the transparency of the top, without always having to remove the solid top.

The top is also sealed, which further adds comfort to the interior of the vehicle.

The disclosed top saves the owner the time and effort required to handle and store bulky vehicle tops.

The sunroof or panoramic roof feature allow occupants to experience sunlight and the sky while being safely and securely within the vehicle interior.

Advantageously, the disclosed top can be installed onto a jeep-type vehicle, without making modifications to vehicle.

It is yet another object of the present invention to provide a removable rooftop that provides protection from weather elements such as wind, rain, hail, sleet, and snow.

Lighting and/or colors enable the interior of the vehicle to glow for added appeal and attention.

The disclosed top allows the owner a very distinctive and unique way to accessorize and customize their vehicle.

The instant invention is lightweight, allowing a single person to mount or remove the rooftop.

Additionally, the rooftop comprises a support wall to allow for a sunroof to be installed into the rooftop if desired.

The foregoing descriptions have been presented for purposes of illustration and description and are not intended to be exhaustive or to limit the presently disclosed subject matter. Many modifications and variations are possible in light of the present disclosure.

What is claimed is:

1. A removable vehicle top, the vehicle top comprising:
a top surface and an opposed bottom surface;
a top edge and an opposed bottom edge;
a pair of parallel side edges;
a length;
a width;
one or more fasteners configured to releasably or permanently attach the top to a corresponding vehicle;
a transparent region that extends through a central portion of the top;
one or more lighting elements positioned on one surface of the top;
wherein the top is removable on a vehicle.

2. The top of claim 1, wherein the transparent region is a sunroof.

3. The top of claim 2, wherein the sunroof is at least partially transparent.

4. The top of claim 1, wherein the transparent region comprises one or more panels constructed from plastic, tempered glass, or combinations thereof.

5. The top of claim 1, further comprising an opaque or partially opaque covering configured to extend over the transparent region.

6. The top of claim 1, wherein the transparent region is tinted.

7. The top of claim 1, wherein the bottom surface of the top comprises a seal that extends about the perimeter of the top.

8. The top of claim 7, wherein the seal is constructed from foam, neoprene, silicone, or combinations thereof.

9. The top of claim 1, wherein the lighting elements are selected from LED lights, halogen lights, electroluminescent lights, fluorescent lights, or combinations thereof.

10. The top of claim 1, wherein the lighting elements are releasably attached to the top and customizable by a user.

11. The top of claim 1, comprising a rounded cutout region in at least one corner.

12. The top of claim 1, wherein a thickness at the top edge differs from a thickness at the bottom edge.

13. The top of claim 1, wherein each lighting element can be activated simultaneously or separate from another lighting element.

14. The top of claim 1, wherein the one or more lighting elements can comprise white lights, colored lights, or both.

15. The top of claim 1, wherein the transparent region, one or more lighting elements, or both can be controlled wirelessly by a user’s phone, tablet, or other device.

16. The top of claim 1, wherein the lighting elements are powered by batteries, solar panels, or the vehicle power source.

17. A vehicle comprising the top of claim 1.

18. A method of positioning a top on a vehicle comprising a removable top, the method comprising:
positioning a removable top over an opening in the roof of a vehicle, wherein the removable top is defined by:
a top surface and an opposed bottom surface;
a length;
a width;
one or more fasteners configured to releasably or permanently attach the top to a corresponding vehicle;
a transparent region that extends through a central portion of the top;
one or more lighting elements positioned on one surface of the top;
securing the removable top to the vehicle;
whereby the top is positioned on the vehicle.

19. The method of claim 18, wherein the lighting elements are selected from LED lights, halogen lights, electroluminescent lights, fluorescent lights, or combinations thereof.

20. The method of claim 18, wherein the transparent region, one or more lighting elements, or both can be controlled wirelessly by a user’s phone, tablet, or other device.
